(19) United States
(12) Patent Application Publication
(10) Pub. No.: US 2018/0287778 A1
(43) Pub. Date: Oct. 4, 2018

(54) A Receiving Node, And Methods Therein, For Estimating A Time Synchronization Position

(71) Applicant: Telefonaktiebolaget LM Ericsson (publ), Stockholm (SE)

(72) Inventors: Dennis Sundman, Solna (SE); Miguel Lopez, Solna (SE); Nafiseh Shariati, Solna (SE)

(21) Appl. No.: 15/765,822

(22) PCT Filed: Oct. 15, 2015
(86) PCT No.: PCT/SE2015/051097

§ 371 Date: Apr. 4, 2018

(51) Int. Cl. H04L 7/04

(52) U.S. Cl. CPC H04L 7/042; H04W 84/12

(57) ABSTRACT

A receiving node 202 and a method therein for estimating a time synchronization position m₀ of a signal received from a transmitting node 204. The receiving node r₁^{w} receives a first signal π from the transmitting node, wherein the first signal comprises a first training signal t₁ⁿ. The first training signal is known to the receiving and transmitting nodes. The receiving node performs a non-linear transformation of the first signal r₁^{w} resulting in a first non-linearly transformed signal r′,r″, and a non-linear transformation of the first training signal resulting in a second non-linearly transformed signal t′,t″. Further, the receiving node performs a cross-correlation of the first non-linearly transformed signal and the second non-linearly transformed signal. The receiving node estimates the time synchronization position of the first signal based on the cross-correlation.

### TECHNICAL FIELD

Embodiments herein relate to a method and a receiving node for estimating a time synchronization position of a signal received from a transmitting node.

### BACKGROUND

In the field of wireless communication, communication devices such as terminals or wireless devices are also known as e.g. User Equipments (UE), mobile terminals, wireless terminals and/or mobile stations. Such terminals are enabled to communicate wirelessly in a wireless communication system, such as a Wireless Local Area Network (WLAN), or a cellular communications network, sometimes also referred to as a cellular radio system or cellular networks. The communication may be performed e.g. between two terminals, between a terminal and a regular telephone, between a terminal and an Access Point (AP), and/or between a terminal and a server via a Access Network (AN) and possibly one or more core networks, comprised within the communications network.

The above terminals or wireless devices may further be referred to as mobile telephones, cellular telephones, laptops, or tablets with wireless capability, just to mention some further examples. The terminals or wireless devices in the present context may be, for example, portable, pocket-storable, hand-held, computer-comprised, or vehicle-mounted mobile devices, enabled to communicate voice and/or data, via the AN, such as a Radio Access Network (RAN), with another entity, such as another terminal or a server.

The communications network covers a geographical area which is divided into geographical subareas, such as coverage areas, cells or clusters. In a cellular communications network each cell area is served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated at the base station site, may serve one or several cells. Further, each base station may support one or several communication technologies. The base stations communicate over the air interface operating on radio frequencies with the terminals or wireless devices within range of the base stations. In the context of this disclosure, the expression Downlink (DL) is used to denote the transmission path from the base station to the mobile station. The expression Uplink (UL) is used to denote the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE typically controlled by the radio base station.

Institute of Electrical and Electronics Engineers (IEEE) 802.11 is a set of Media Access Control (MAC) and PHYsical layer (PHY) specifications for implementing Wireless Local Area Network (WLAN) computer communication in the 2.4, 3.6, 5, and 60 GHz frequency bands. They are created and maintained by the IEEE Local Area Network (LAN)/Metropolitan Area Network (MAN) Standards Committee (IEEE 802). The base version of the standard was released in 1997, and has had subsequent amendments. The standard and amendments provide a local area wireless computer networking technology that allows electronic devices to connect to a network. A WLAN is sometimes referred to as a WiFi network.

Accurate time synchronization is important in any communication technology. In contention based communication technologies, such as in a WLAN according to e.g. the IEEE 802.11, time synchronization is implicit in the sense that signal bursts transmitted from a transmitter, e.g. a transmitting node, have to be detected by a receiver, e.g. a receiving node. By the expression “signal burst” when used herein is meant a burst of one or more signals.

Detection of an IEEE 802.11 signal burst may be performed through continuous measurement of received energy, and/or by detecting a known training field carried by the signal burst. After the receiver has detected a signal burst, the receiver performs a refined time synchronization by exploiting repetitiveness in the training field of the received communication burst. In the IEEE 802.11ah, the training field is composed of two parts; a Short Training Field (STF) and a Long Training Field (LTF). The STF is typically used for automatic gain control, time synchronization and coarse frequency offset estimation. The LTF is additionally used to refine the frequency offset estimation and for channel estimation.

The frequency offset of the received signal is a distortion of the original signal, where the distortion originates from the fact that the internal clocks of the transmitter and the receiver are not perfectly synchronized. This offset creates a distortion such that each consecutive sample of the received signal, represented in the complex plane, rotates compared to the non-distorted signal. For sensor devices where the sensor has been asleep and recently woke up, larger frequency offsets are expected. Cheap hardware may also result in larger frequency offsets.

The STF in the IEEE 802.11ah is constructed by repeating ten or twenty times a time domain pattern. The number of times the time domain pattern is repeated differs depending on the channel bandwidth, i.e., for 1 MHz channel bandwidth it is twenty repetitions, whereas for channel bandwidths greater than or equal to 2 MHz it is ten repetitions.

It should be noted that frequency offsets in IEEE 802.11 WLAN's may be very large. For example, in an IEEE 802.11ah WLAN, the frequency offset may be as large as 18 kHz, and typical frequency offsets may be in the order of several kHz. In the presence of large frequency offsets, the received signal rotates to such an extent that it is hard to determine if the signal is just noise, or if it is useful information. Under this condition, the performance of time synchronization schemes relying on detecting similarities between the training signal and the received signal degrade significantly. In order to address this issue, the effect of the frequency offset needs to be alleviated. Prior art solutions are focused on exploiting the repetitions in the STF to alleviate the effect of the frequency offset and thus perform time synchronization. For example, by correlating a received signal with a windowed, delayed version of itself, the repetitions in the STF may be detected. An illustration of how this is performed is shown in FIG. 1. This kind of time synchronization is in this disclosure sometimes referred to as a legacy synchronization, e.g., a legacy autocorrelation time synchronization. A drawback with the legacy synchronization is its dependency on the repetitive structure of the STF which as a result limits the use of samples of the received signal. Then, in some scenarios, e.g., at low SNR's, not having enough samples results in performance degradation.

### SUMMARY

An object of embodiments herein is to overcome the above-mentioned drawbacks among others and to improve the performance in a communications network.

According to a first aspect of embodiments herein, the object is achieved by a method performed by a receiving node for estimating a time synchronization position of a signal received from a transmitting node.

The receiving node receives a first signal from the transmitting node, wherein the first signal comprises a first training signal. The first training signal is known to both the receiving node and the transmitting node.

The receiving node performs a non-linear transformation of the first signal resulting in a first non-linearly transformed signal.

Further, the receiving node performs the non-linear transformation of the first training signal resulting in a second non-linearly transformed signal.

Furthermore, the receiving node performs a cross-correlation of the first non-linearly transformed signal and the second non-linearly transformed signal.

Yet further, the receiving node estimates the time synchronization position of the first signal based on the cross-correlation.

By the expression “time synchronization position of the first signal” when used herein is meant a position that corresponds to or indicate a beginning of the training signal comprised in the first signal.

According to a second aspect of embodiments herein, the object is achieved by a receiving node for estimating a time synchronization position of a signal received from a transmitting node.

The receiving node is configured to receive a first signal from the transmitting node, wherein the first signal comprises a first training signal. The first training signal is known to both the receiving node and the transmitting node.

The receiving node is configured to perform a non-linear transformation of the first signal resulting in a first non-linearly transformed signal.

Further, the receiving node is configured to perform the non-linear transformation of the first training signal resulting in a second non-linearly transformed signal.

Furthermore, the receiving node is configured to perform a cross-correlation of the first non-linearly transformed signal and the second non-linearly transformed signal.

Yet further, the receiving node is configured to estimate the time synchronization position of the first signal based on the cross-correlation.

According to a third aspect of embodiments herein, the object is achieved by a computer program, comprising instructions which, when executed on at least one processor, causes the at least one processor to carry out the method performed by the receiving node.

According to a fourth aspect of embodiments herein, the object is achieved by a carrier comprising the computer program, wherein the carrier is one of an electronic signal, an optical signal, a radio signal or a computer readable storage medium.

Since the first signal and the training signal are non-linearly transformed, and since the non-linearly transformed signals are cross-correlated, any effects of frequency offsets are eliminated or reduced. The reason for that is that prior to non-linear transformation, in the complex representation of the received samples, each consecutive time sample is rotated compared to the previous sample due to the existing frequency offset. In other words, the rotation is an increasing function of the sample index. By non-linear transformation that is time-delaying the whole signal and by multiplying with its complex conjugate, the rotation of each sample becomes independent of the sample index. In other words, the rotation is constant for all the samples in the non-linearly transformed signal. This constant rotation of the whole signal is not a problem for most packed detection algorithms. Thereby, the time synchronisation position may be determined with an improved accuracy. This results in an improved performance in the communications network.

An advantage with embodiments herein is that they are robust to frequency offsets while achieving equal or better performance than existing solutions, such as the legacy synchronization.

Another advantage is that it is ensured that, when compared to the legacy synchronization, embodiments herein allow the use of more samples of the received signal in order to estimate the time synchronization position. This is advantageous, especially at low SNR's.

### BRIEF DESCRIPTION OF DRAWINGS

Examples of embodiments herein will be described in more detail with reference to attached drawings in which:

FIG. 1 schematically illustrates legacy time synchronization according to prior art;

FIG. 2 schematically illustrates an embodiment of a communications network;

FIG. 3 is a flowchart depicting embodiments of a method performed by a receiving node;

FIGS. 4A and 4B schematically illustrate examples of a first signal;

FIG. 5 is a schematic block diagram illustrating embodiments of a receiving node;

FIG. 6 is a combined flow chart and block diagram illustrating embodiments of methods for estimating the time synchronization position;

FIG. 7 schematically illustrates performance plots for the prior art legacy synchronization and for embodiments herein; and

FIG. 8 is a combined flow chart and block diagram illustrating embodiments of methods for estimating the time synchronization position.

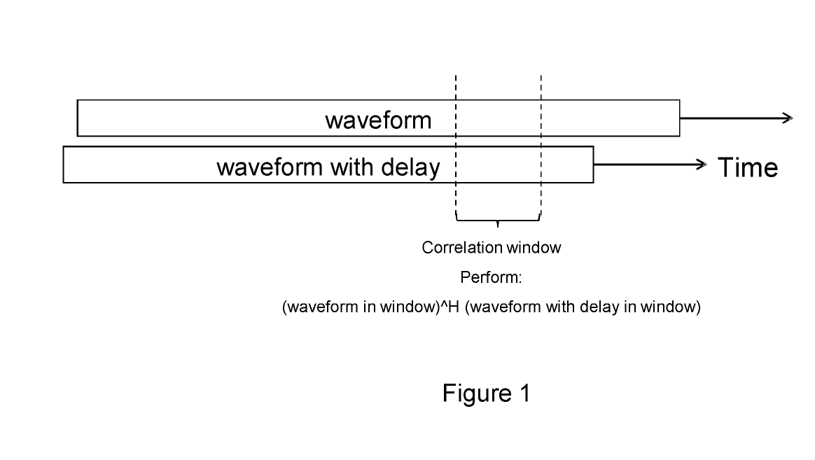

### DETAILED DESCRIPTION

As part of developing embodiments herein, some problems with the state of the art communications systems will first be identified and discussed.

The IEEE 802.11ah introduces a new Modulation and Coding Scheme (MCS) called MCS10, which is even more robust than the MCS's used in previous versions of the IEEE 802.11 standard, such as in the IEEE 802.11ac or the IEEE 802.11n. The new MCS is designed to operate at very low SNR's. However, since an extended coverage is one of the main advantages of the IEEE 802.11ah, the legacy synchronization algorithms are stressed by MCS10. The reason for that is that the operating point of MCS10 is very low, possibly at negative SNR, where accurate detection of a transmission and estimation of the information content of the transmission are challenging. Therefore, low complexity time synchronization methods that give accurate time synchronization estimates at low SNR's are highly desirable. More generally, the performance of a receiver, e.g. a receiving node, depends on accurate timing estimates, and therefore improvements in the synchronization performance are typically desirable in order to improve the performance of the receiver. Thereby, the performance of the communications network can also be improved, which will be explained in more detail below.

Therefore, some embodiments described herein, eliminate the effect of frequency offsets by performing a non-linear transformation of a received signal, by applying the same non-linear transformation to a known training signal and by applying matched filtering on the modified signals, e.g. on the non-linearly transformed received signal and the non-linearly transformed training signal. In other words, a non-linearly transformed received signal is matched to a non-linearly transformed training signal. The matched filter may be realized by performing a cross correlation of the non-linearly transformed received signal and the non-linearly transformed training signal. The transformation is done such as to reduce, or remove, the effects of frequency offsets. As previously described, prior to the non-linear transformation, in the complex representation of the received samples, each consecutive time sample is rotated compared to the previous sample due to the existing frequency offset. In other words, the rotation is an increasing function of the sample index. By the non-linear transformation that is time-delaying the whole signal and by multiplying with its complex conjugate, the rotation of each sample becomes independent of the sample index. In other words, the rotation is constant for all the samples in the non-linearly transformed signal. Thus, the effects of frequency offsets are reduced or removed.

In some embodiments herein, the received signal, e.g. a received baseband signal, is, sample by sample, multiplied with a delayed, e.g. time delayed, and conjugated version of itself. The same operation is performed on the known training signal, e.g. a known training field sequence, comprising all or part of the STF and the LTF. Then a matched filter, e.g. a cross-correlation, is performed on the time delayed and conjugated signals. The result of the matched filter is then used to estimate the time synchronization position. In some embodiments herein, the time synchronization position is estimated to correspond to the sample having the largest value of the cross-correlation.

In more detail, both the received signal and a known training signal are subjected to a non-linear transformation. This non-linear transformation comprises the following actions. Firstly, a copy of an input signal, e.g. the received signal or the training signal, is created. Secondly, a complex conjugation is applied to either signal, e.g. to either the input signal or to the copy of the input signal. Thirdly, at least one of the signals is delayed or advanced, e.g. time shifted. Fourthly, the two signals are multiplied element-wise. Afterwards, the non-linearly transformed received signal and the non-linearly transformed training signal are cross-correlated. The synchronization position, e.g. the time synchronization position, is estimated by finding the peak of this cross-correlation.

Terminology

The following terminology is used in embodiments described herein and is elaborated below:

Network node: In some embodiments a more general term “network node” is used and it may correspond to any type of network node or radio network node, which communicates with a UE and/or with another network node. Examples of network nodes are User equipment (UE), NodeB, MeNB, SeNB, a network node belonging to a Master Cell Group (MCG) or a Secondary Cell Group (SCG), Base Station (BS), multi-Standard Radio (MSR) radio node such as MSR BS, eNodeB, network controller, radio Network Controller (RNC), Base Station Controller (BSC), relay, donor node controlling relay, Base Transceiver Station (BTS), Access Point (AP), transmission points, transmission nodes, Radio Remote Unit (RRU), Remote Radio Head (RRH), nodes in Distributed Antenna System (DAS), core network node (e.g. Mobile Switching Center (MSC), Mobility Management Entity (MME) etc), Operations and Maintenance (O&M), Operations Support System (OSS), Self-organizing Network (SON), positioning node (e.g. Enhanced Serving Mobile Location Center (E-SMLC)), Mobile Data Terminal (MDT) etc.

User equipment/wireless device: In some embodiments the non-limiting terms wireless device and User Equipment (UE) are used and they refer to any type of wireless device communicating with a network node or with another UE in a cellular or mobile communication system. Examples of UE/wireless device are Device-to-Device (D2D) UE, machine type UE or UE capable of machine to machine (M2M) communication, Personal Digital Assistant (PDA), Tablet, mobile terminals, smart phone, Laptop Embedded Equipped (LEE), Laptop Mounted Equipment (LME), Universal Serial Bus (USB) dongles etc. In this disclosure the terms wireless device and UE are used interchangeably.

General

Note that although terminology from 3GPP LTE has been used in this disclosure to exemplify embodiments, this should not be seen as limiting the scope of the invention to only the aforementioned system. Other wireless systems, including Wideband Code Division Multiple Access (WCDMA), High Speed Packet Access (HSPA), Worldwide Interoperability for Microwave Access (WiMax), WiFi, Wireless Local Area Network (WLAN), and Global System for Mobile Communications (GSM)/GSM EDGE Radio Access Network (GERAN), may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” device 2, and these two devices communicate with each other over some radio channel.

Further, the description frequently refers to wireless transmissions in the downlink, but embodiments herein are equally applicable in the uplink.

Furthermore, the embodiments are described in the context of single carrier operation of the UE. However, the embodiments are applicable for multi-carrier or carrier aggregation operation of the UE. Therefore, the embodiment methods of signaling information to the UE or to the other network node may be carried out independently for each cell on each carrier frequency supported by the network node.

In the following section, embodiments herein will be illustrated in more detail by various exemplary embodiments. It should be noted that these embodiments are not mutually exclusive. Components from one embodiment may be assumed to be present in another embodiment and it will be obvious to a person skilled in the art how those components may be used in the other exemplary embodiments.

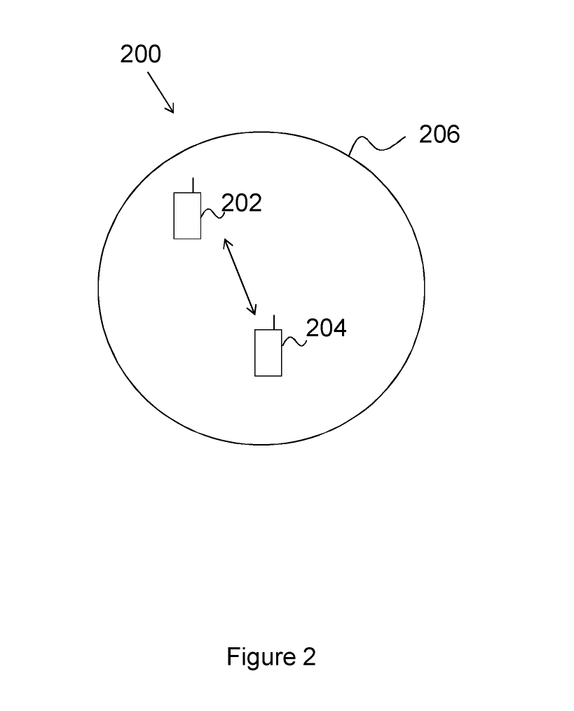

FIG. 2 depicts an example of a communications network 200 in which embodiments herein may be implemented. The communications network 200 is a wireless communication network such as a WLAN, an LTE network, a WCDMA network, a GSM network, any 3GPP cellular network, WiMAX network, any other wireless network, or a combination of one or more of the aforementioned communications networks.

A first network node, such as a receiving node 202, may be comprised in the communications network 200. The receiving node 202 is configured to operate in the communications network 200. In other words, the receiving node 202 is operable in the communications network 200.

A second network node, such as a transmitting node 204, may be comprised in the communications network 200. The transmitting node 204 is configured to operate in the communications network 200. In other words, the transmitting node 204 is operable in the communications network 200.

It should be understood that the first and the second network nodes 202 and 204 may be configured to both transmit and receive a transmission such as a signal. However, in this disclosure one of these nodes 202, 204 is transmitting the signal and the other one is receiving the signal, and thus they are referred to as a transmitting node and a receiving node, respectively.

Each of the network nodes 202 and 204 may be an access node or a wireless device.

The access node, e.g. a wireless access node, may be a WLAN access node, a radio access node such as a radio base station, for example an eNB, an eNodeB, or a Home Node B, an Home eNode B or any other network node capable to serve and/or communicate with a user equipment or a machine type communication device in the communications network 200.

Further, both network nodes 202, 204 are configured for wireless communication with each other, when being located within a geographical area 206 served by one of the network nodes, e.g. the transmitting node 204. The receiving node 202 may in such cases be a wireless device. Herein, this is also specified as the transmitting node 204 manages or is configured to manage communication with one or more receiving nodes 202 in the geographical area 206. In this disclosure, the geographical area 206 is sometimes also referred to as a coverage area, a cell or a cluster.

The wireless device, also referred to as a user equipment or UE, is located in the communications network 200. The wireless device may e.g. be a user equipment, a mobile terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network. It should be noted that the term user equipment used in this document also covers other wireless devices such as Machine to Machine (M2M) devices, even though they are not handled by any user.

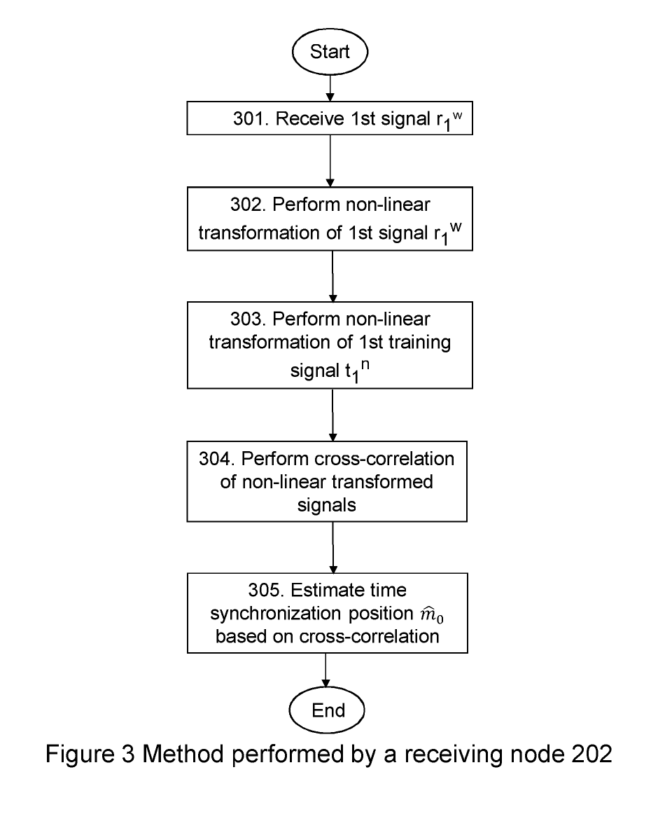

An example of a method performed by the receiving node 202 for estimating a time synchronization position \hat{m}₀ of a signal received from the transmitting node 204 will now be described with reference to a flowchart illustrated in FIG. 3 and with further reference to FIG. 2. As mentioned above, the receiving node 202 and the transmitting node 204 are operating in the communications network 200.

As previously mentioned, by the expression “time synchronization position of a signal” when used herein is meant a position that corresponds to or indicate a beginning of a training signal comprised in a first signal. The method comprises one or more of the following actions. It should be understood that some actions are optional, that some actions may be taken in another suitable order and that actions may be combined.

Action 301

The receiving node 202 receives a first signal r₁^{w} from the transmitting node 204.

The first signal r₁^{w} comprises a first training signal t₁ⁿ that is known to both the receiving node 202 and the transmitting node 204. Thus, the receiving node 202 has knowledge e.g. previous knowledge, about the training signal t₁ⁿ before it receives the first signal r₁^{w}.

The first signal r₁^{w} may comprise payload, such as data and/or signalling information.

As will be described in the Actions below, based on the first signal r₁^{w} and on the known training signal t₁ⁿ, the receiving node 202 will be able to determine and/or estimate the time synchronization position \hat{m}₀ of the first signal r₁^{w}. The time synchronization position \hat{m}₀ corresponds to or indicates the beginning, e.g. a start position, of the training signal t₁ⁿ comprised in the first signal r₁^{w}. Since the receiving node 202 has knowledge, about the training signal t₁ⁿ it will have knowledge about the length of the training signal t₁ⁿ. Thus, based on the estimated time synchronization position \hat{m}₀ and on the length of the training signal t₁ⁿ, the receiving node 202 may determine the beginning, e.g. a start position, of data and/or signalling information comprised in the first signal. In other words, based on the estimated time synchronization position \hat{m}₀ and on previous knowledge about the training signal t₁ⁿ, the receiving node 202 will be able to determine at which position reading of payload, e.g. data and/or signalling information, comprised in the signal is to be started.

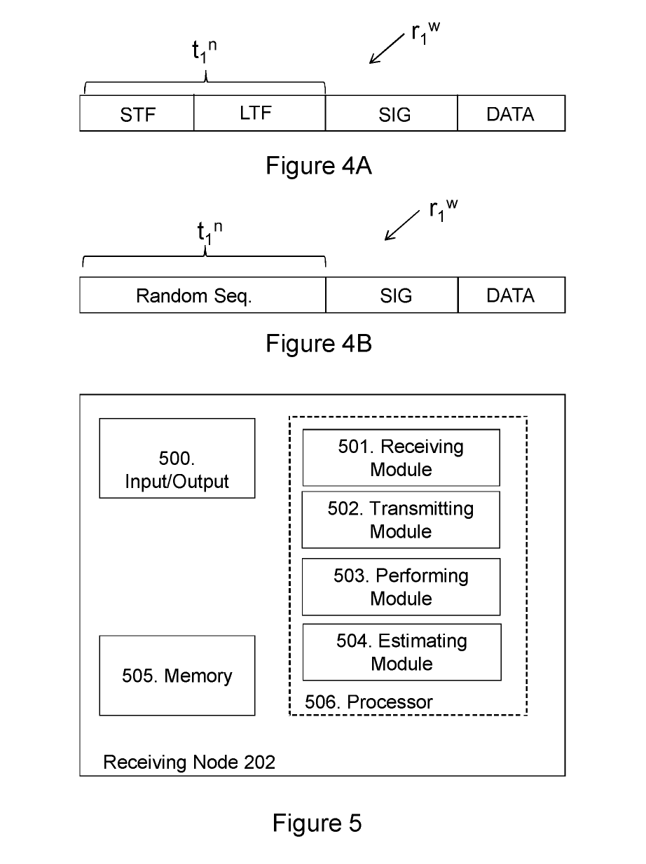

FIGS. 4A and 4B schematically illustrate examples of the structure of the first signal r₁^{w}.

In FIG. 4A, the first signal r₁^{w} comprises a training signal t₁ⁿ that comprises a Short Training Field (STF) and also a Long Training Field (LTF) in this example. Further, the first signal r₁^{w} may comprise signalling information (SIG) and/or data (DATA). It should be understood that in other examples the training signal t₁ⁿ may comprise one of the STF and the LTF, or a combination of both the STF and the LTF. Further, it may comprise the complete STF and/or the complete LTF, or a part of the STF and/or a part of the LTF.

In FIG. 4B, the first signal r₁^{w} comprises a training signal t₁ⁿ that comprises a random sequence. For example, the random sequence may be a random white noise sequence. Further, as previously mentioned, the first signal r₁^{w} may comprise signalling information (SIG) and/or data (DATA).

Further, the first signal r₁^{w} may comprise the random sequence in addition to the STF and/or the LTF or parts thereof.

Action 302

In order to reduce or eliminate the effects of frequency offsets in the received first signal, the receiving node 202 performs a non-linear transformation of the first signal r₁^{w}, which non-linear transformation results in a first non-linearly transformed signal r′,r″.

In some embodiments, receiving node 202 performs the non-linear transformation of the first signal r₁^{w} by creating a second signal r₂^{w} as a copy of the first signal r₁^{w}, and by performing a complex-conjugation of the first signal r₁^{w} or the second signal r₂^{w}, which complex-conjugation results in a complex-conjugated signal and a non-complex conjugated signal. Further, the receiving node 202 performs the non-linear transformation of the first signal r₁^{w} by time-shifting the complex-conjugated signal and the non-complex conjugated signal in relation to each other; and by element-wise multiplying with each other the complex-conjugated signal and the non-complex conjugated signal, which complex-conjugated signal and non-complex conjugated signal are time-shifted in relation to each other.

In some embodiments, the first non-linearly transformed signal r′ is given by:

r′(k)=r(k)r*(k+d), k=1, . . . , w−d,

wherein k is the sample index, w is a window length of a buffer for a received signal, d is a sample delay, and the expression “*” denotes element-wise complex conjugation. For example, this may be the case when the sample delay d is small. By the expression “a small sample delay d” when used in this disclosure is meant a sample delay d that is smaller than, for example, n/2, wherein n is the length of the training signal.

The sample delay is a time delay of the signal. Sometimes in this disclosure the sample delay is referred to as a time shift or a lag. It should be understood that the terms sample delay, time shift and lag are used interchangeably, and that they may have a positive value or a negative value. Thus, the signals may be delayed or advanced as long as they are time shifted in relation to each other.

Alternatively, in some embodiments, the first non-linearly transformed signal r″ is given by:

$${r}^{″} ( k ) = \{ \begin{matrix}r ( k + d ) {r}^{*} ( k ) , & k = 1 , … w - d \\ r ( k - w + d ) {r}^{*} ( k ) , & k = w - d + 1 , … , w\end{matrix}$$

wherein k is the sample index, d is the sample delay, w is the window length of a buffer for a received signal, and the expression “*” denotes element-wise complex conjugation. For example, this may be the case when the sample delay d is large. By the expression “a large sample delay d” when used in this disclosure is meant a sample delay d that is larger than, for example, n/2, where n is the length of the training signal.

Action 303

In order to reduce or eliminate the effects of frequency offsets in the received first signal, the receiving node 202 performs the non-linear transformation of the first training signal t₁ⁿ, which non-linear transformation results in a second non-linearly transformed signal t′,t″. Further, this is performed in order to be able to compare the training signal with the received signal. Thus, in order to be able to compare the training signal and the received signal, the training signal should be modified, e.g. non-linear transformed, similarly to the received signal.

In some embodiments, the receiving node 202 performs the non-linear transformation of the first training signal t₁ⁿ by creating a second training signal t₂ⁿ as a copy of the first training signal t₁ⁿ; and by performing a complex-conjugation of the first training signal t₁ⁿ or the second training signal t₂ⁿ, which complex-conjugation results in a complex-conjugated training signal and a non-complex conjugated training signal. Further, the receiving node 202 performs the non-linear transformation of the first training signal t₁ⁿ by time-shifting the complex-conjugated training signal and the non-complex conjugated training signal in relation to each other; and by element-wise multiplying with each other the complex-conjugated training signal and the non-complex conjugated training signal, which complex-conjugated training signal and non-complex conjugated training signal are time-shifted in relation to each other.

In some embodiments, the second non-linearly transformed signal t′ is given by:

t′(k)=t(k)t*(k+d), k=1, . . . , n−d,

wherein k is the sample index, n is a length of the first training signal, d is the sample delay, and wherein the expression “*” denotes element-wise complex conjugation. For example, this may be the case when the sample delay d is small.

Alternatively, in some embodiments, the second non-linearly transformed signal t″ is given by:

$${t}^{″} ( k ) = \{ \begin{matrix}t ( k + d ) {t}^{*} ( k ) , & k = 1 , … n - d \\ t ( k - n + d ) {t}^{*} ( k ) , & k = n - d + 1 , … , n\end{matrix}$$

wherein k is the sample index, d is the sample delay, n is a length of the first training signal, and the expression “*” denotes element-wise complex. For example, this may be the case when the sample delay d is large.

Action 304

The receiving node 202 performs a cross-correlation of the first non-linearly transformed signal r′,r″ and the second non-linearly transformed signal t′,t″. This is performed, in order to measure the similarity between the two non-linearly transformed signals r′,t′ and/or r″,t″ to determine where they exactly overlap with each other.

In some embodiments, the receiving node 202 performs the cross-correlation of the first non-linear transformed (r′) and the second non-linear transformed signal t′ as:

y(m)=Σₗ₌₁^{n-d}(r′(l+m−1))*t′(l),

wherein y(m) is a cross-correlated signal, m is a sample index, and the expression “*” denotes element-wise complex conjugation. For example, this may be the case when the sample delay d is small.

Alternatively, in some embodiments, the receiving node 202 performs the cross-correlation of the first non-linearly transformed signal r″ and the second non-linear transformed signal t″ as:

y″(m)=Σₗ₌₁ⁿ(r″(l+m−1))*t″(l),

wherein y″(m) is a cross-correlated signal, m is a sample index, and the expression “*” denotes element-wise complex conjugation. For example, this may be the case when the sample delay d is large.

Action 305

In order to determine and/or estimate the time synchronization position \hat{m}₀ of the first signal r₁^{w}, the receiving node 202 estimates the time synchronization position \hat{m}₀ of the first signal r₁^{w} based on the cross-correlation. By using this method, almost all samples contribute to the estimate of the time synchronization position. Thus, this estimate may be more accurate compared to for example the legacy synchronization where only parts of samples are exploited. If the time synchronization position estimate is not correct, decoding of the first signal r₁^{w} is not possible. Furthermore, because of the non-linear transformation to the signals, the quality of the estimation remains unchanged even under large frequency offsets.

In some embodiments, the receiving node 202 estimates the time synchronization position \hat{m}₀ of the first signal r₁^{w} based on the cross-correlation by estimating the synchronization position \hat{m}₀ based on a maximum value or a minimum value of the cross-correlation.

In some embodiments, the receiving node 202 estimates the time synchronization position \hat{m}₀ of the first signal r₁^{w} based on the cross-correlation by estimating the time synchronization position \hat{m}₀ as

\hat{m}₀=arg maxₘ{|y(m)|}+d,

wherein y(m) is the cross-correlated signal, is a sample index, and d is the sample delay. This may be the case when the first non-linearly transformed signal r′ is given by r′(k)=r(k)r*(k+d), k=1, . . . , w−d, and when the second non-linearly transformed signal t′ is given by t′(k)=t(k)t*(k+d), k=1, . . . , n−d. Thus, this may be the case when the sample delay d is small.

Alternatively, in some embodiments, the receiving node 202 estimates the time synchronization position \hat{m}₀ of the first signal r₁^{w} based on the cross-correlation by estimating the time synchronization position \hat{m}₀ as

\hat{m}₀=arg maxₘ{|y″(m)|},

wherein y″(m) is the cross-correlated signal, m is the sample index, and d is the sample delay. This may be the case when the first non-linearly transformed signal r″ is given by

$${r}^{″} ( k ) = \{ \begin{matrix}r ( k + d ) {r}^{*} ( k ) , & k = 1 , … w - d \\ r ( k - w + d ) {r}^{*} ( k ) , & k = w - d + 1 , … , w\end{matrix}$$

and when the second non-linearly transformed signal t″ is given by

$${t}^{″} ( k ) = \{ \begin{matrix}t ( k + d ) {t}^{*} ( k ) , & k = 1 , … n - d \\ t ( k - n + d ) {t}^{*} ( k ) , & k = n - d + 1 , … , n\end{matrix} .$$

this may be the case when the sample delay d is large.

To perform the method for estimating a time synchronization position \hat{m}₀ of the signal received from the transmitting node 204, the receiving node 202 may be configured according to an arrangement depicted in FIG. 5. As mentioned above, the receiving node 202 and the transmitting node 204 are operating in the communications network 200.

In some embodiments, the receiving node 202 comprises an input and output interface 500 configured to communicate with one or more the network nodes e.g. the transmitting node 204. The input and output interface 500 may comprise a wireless receiver (not shown) and a wireless transmitter (not shown).

The receiving node 202 is configured to receive, by means of a receiving module 501 configured to receive, the first signal r₁^{w} from the transmitting node 204. The first signal r₁^{w} comprises a first training signal t₁ⁿ, which first training signal t₁ⁿ is known to both the receiving node 202 and the transmitting node 504. The receiving module 501 may be implemented by or arranged in communication with a processor 506 of the receiving node 202. The processor 506 will be described in more detail below.

As previously mentioned, the first signal r₁^{w} may comprise payload, such as data and/or signalling information.

As also previously mentioned, the training signal t₁ⁿ may comprise one of the STF and the LTF, or a combination of both the STF and the LTF. Further, it may comprise all of the STF and/or all of the LTF, or a part of the STF and/or a part of the LTF. Alternatively or additionally, the training signal t₁ⁿ may comprise a random sequence.

The receiving node 202 is configured to transmit, by means of a transmitting module 502 configured to transmit, e.g. a signal to another network node. The transmitting module 502 may be implemented by or arranged in communication with the processor 506 of the receiving node 202.

The receiving node 202 is configured to perform, by means of a performing module 503 configured to perform, a non-linear transformation of a signal. The performing module 503 may be implemented by or arranged in communication with the processor 506 of the receiving node 202.

The receiving node 202 is configured to perform a non-linear transformation of the first signal r₁^{w} resulting in a first non-linearly transformed signal r′,r″, and to perform the non-linear transformation of the first training signal t₁ⁿ resulting in a second non-linearly transformed signal t′,t″.

Further the receiving node 202 is configured to perform a cross-correlation of the first non-linearly transformed signal r′,r″ and the second non-linearly transformed signal t′,t″.

In some embodiments, the receiving node 202 is configured to perform the non-linear transformation of the first signal r₁^{w} by being configured to create a second signal r₂^{w} as a copy of the first signal r₁^{w} and to perform a complex-conjugation of the first signal r₁^{w} or the second signal r₂^{w}, which complex-conjugation results in a complex-conjugated signal and a non-complex conjugated signal. Further, the receiving node 202 may be configured to time-shift the complex-conjugated signal and the non-complex conjugated signal in relation to each other; and to element-wise multiply with each other the complex-conjugated signal and the non-complex conjugated signal, which complex-conjugated signal and non-complex conjugated signal are time-shifted in relation to each other.

In some embodiments, the receiving node 202 is configured to perform the non-linear transformation of the first training signal t₁ⁿ by being configured to create a second training signal t₂ⁿ as a copy of the first training signal t₁ⁿ, and to perform a complex-conjugation of the first training signal t₁ⁿ or the second training signal t₂ⁿ, which complex-conjugation results in a complex-conjugated training signal and a non-complex conjugated training signal. Further, the receiving node 202 may be configured to time-shift the complex-conjugated training signal and the non-complex conjugated training signal in relation to each other, and to element-wise multiply with each other the complex-conjugated training signal and the non-complex conjugated training signal, which complex-conjugated training signal and non-complex conjugated training signal are time-shifted in relation to each other.

In some embodiments, the first non-linearly transformed signal r′ is given by:

r′(k)=r(k)r*(k+d), k=1, . . . , w−d.

where k is the sample index, w is a window length of a buffer for a received signal, d is the sample delay, and the expression “*” denotes element-wise complex conjugation. As previously mentioned, this may be the case when the sample delay d is small.

In some embodiments, the second non-linearly transformed signal t′ is given by:

t′(k)=t(k)t*(k+d), k=1, . . . , n−d.

wherein k is the sample index, n is a length of the first training signal, d is the sample delay, and wherein the expression “*” denotes element-wise complex conjugation. As previously mentioned, this may be the case when the sample delay d is small.

In some embodiments, wherein the first non-linear transformed signal is given by r′ and the second non-linear transformed signal is given by t′, the receiving node 502 is configured to perform the cross-correlation of the first non-linear transformed r′ and the second non-linear transformed signal t′ as:

y(m)=Σₗ₌₁^{n-d}(r′(l+m−1))*t′(l),

wherein y(m) is a cross-correlated signal, m is a sample index, and the expression “*” denotes element-wise complex conjugation.

In some embodiments, the first non-linearly transformed signal r″ is given by:

$${r}^{″} ( k ) = \{ \begin{matrix}r ( k + d ) {r}^{*} ( k ) , & k = 1 , … w - d \\ r ( k - w + d ) {r}^{*} ( k ) , & k = w - d + 1 , … , w\end{matrix}$$

wherein k is the sample index, d is the sample delay, w is the window length of a buffer for a received signal, and the expression “*” denotes element-wise complex conjugation. As previously mentioned, this may be the case when the sample delay d is large.

In some embodiments, the second non-linearly transformed signal t″ is given by:

$${t}^{″} ( k ) = \{ \begin{matrix}t ( k + d ) {t}^{*} ( k ) , & k = 1 , … n - d \\ t ( k - n + d ) {t}^{*} ( k ) , & k = n - d + 1 , … , n\end{matrix}$$

wherein k is the sample index, d is the sample delay, n is a length of the first training signal, and the expression “*” denotes element-wise complex. As previously mentioned, this may be the case when the sample delay d is large.

In some embodiments, wherein the first non-linear transformed signal is given by r″ and the second non-linear transformed signal is given by t″, the receiving node 502 is configured to perform the cross-correlation of the first non-linearly transformed signal r″ and the second non-linear transformed signal t″ as:

y″(m)=Σₗ₌₁^{n-d}(r″(l+m−1))*t″(l),

wherein y″(m) is a cross-correlated signal, m is a sample index, and the expression “*” denotes element-wise complex conjugation.

The receiving node 202 is configured to estimate, by means of an estimating module 504 configured to estimate, the time synchronization position \hat{m}₀ of the first signal r₁^{w} based on the cross-correlation. The estimating module 504 may be implemented by or arranged in communication with the processor 506 of the receiving node 202. The estimating module 504 may sometimes in this disclosure be referred to as a determining module configured to determine the time synchronization position \hat{m}₀ of the first signal r₁^{w} based on the cross-correlation.

In some embodiments, the receiving node 202 is configured to estimate the time synchronization position \hat{m}₀ of the first signal r₁^{w} based on the cross-correlation by being configured to estimate the synchronization position \hat{m}₀ based on a maximum value or a minimum value of the cross-correlation.

In some embodiments, wherein the first non-linear transformed signal is given by r′ and the second non-linear transformed signal is given by t′, the receiving node 202 is configured to estimate the time synchronization position \hat{m}₀ of the first signal r₁^{w} based on the cross-correlation by being configured to estimate the time synchronization position \hat{m}₀ as

\hat{m}₀=arg maxₘ{|y(m])|}+d,

wherein y(m) is the cross-correlated signal, m is a sample index, and d is the sample delay. As previously mentioned, this may be the case when the sample delay d is small.

In some embodiments, wherein the first non-linear transformed signal is given by r″ and the second non-linear transformed signal is given by t″, the receiving node 202 is configured to estimate the time synchronization position \hat{m}₀ of the first signal r₁^{w} based on the cross-correlation by being configured to estimate the time synchronization position \hat{m}₀ as

\hat{m}₀=arg maxₘ{|y″(m)|},

wherein y″(m) is the cross-correlated signal, m is the sample index, and d is the sample delay. As previously mentioned, this may be the case when the sample delay d is large.

The receiving node 202 may also comprise means for storing data. In some embodiments, the receiving node 202 comprises a memory 505 configured to store the data. The data may be processed or non-processed data and/or information relating thereto. The memory 505 may comprise one or more memory units. Further, the memory 505 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the receiving node 202.

Embodiments herein for estimating the time synchronization position \hat{m}₀ of the signal received from the transmitting node 204 may be implemented through one or more processors, such as the processor 506 in the arrangement depicted in FIG. 5, together with computer program code for performing the functions and/or method actions of embodiments herein. The program code mentioned above may also be provided as a computer program product, for instance in the form of a data carrier carrying computer program code for performing the embodiments herein when being loaded into the receiving node 502. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the receiving node 202.

Those skilled in the art will also appreciate that the input/output interface 500, the receiving module 501, the transmitting module 502, the performing module 503 and the estimating module 504 above may refer to a combination of analog and digital circuits, and/or one or more processors configured with software and/or firmware, e.g. stored in the memory 505, that when executed by the one or more processors such as the processors in the receiving node 202 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### Exemplifying Embodiments

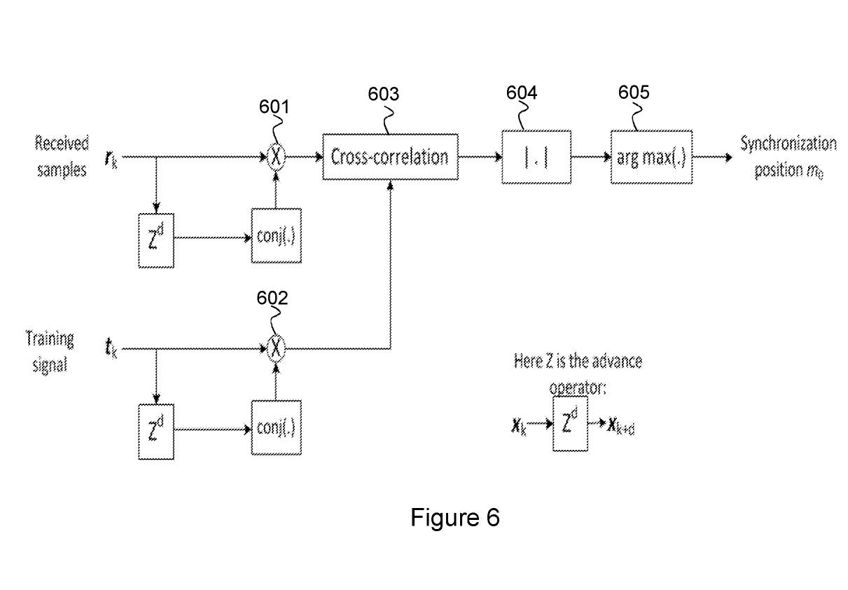

Some examples of how the above embodiments may be implemented in practice will now be described with reference to FIG. 6 that schematically illustrates a block diagram comprising functional entities or blocks which can be used for estimating the time synchronization position \hat{m}₀.

As schematically illustrated in FIG. 6, in a block 601, sample by sample, a received baseband signal rₖ is multiplied with a delayed and conjugated version of itself. In the FIG. 6, z^{d} illustrates an advance/delay operator and d is the lag. Further, in a block 602, the same operation is performed with the training field sequence tₖ comprising all or parts of the STF and LTF. Further, in a block 603, a matched filter is performed, e.g. the outputs from the first and second actions are cross-correlated. In a block 604, the absolute value of an input is taken as an output. This is illustrated with the notation |.|. Thus, the result of the cross-correlation performed in block 603 is given as input to block 604 and the output of block 604 is the absolute value of the result of the cross-correlation. Then, in a block 605, the output of the matched filter is used to estimate the synchronization position \hat{m}₀.

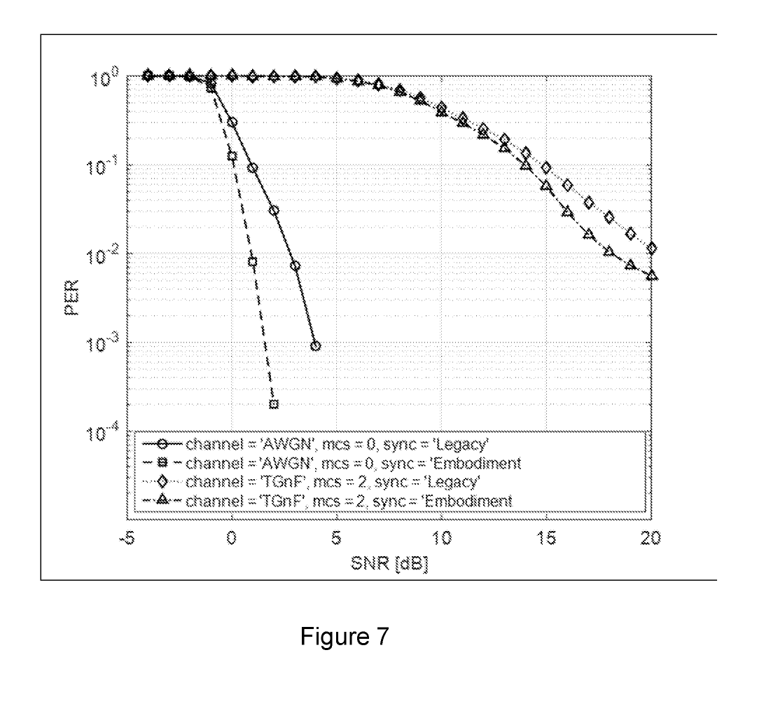

FIG. 7 schematically illustrates performance plots for the prior art legacy synchronization referred to as “legacy” and for the method according to embodiments herein that is referred to as “Embodiment”. The channel models in this example are AWGN and IEEE TGn F. This example is for 802.11ah using the short preamble and 2 MHz bandwidth. It is to be noted that the embodiments disclosed herein outperform the prior art.

Embodiments herein, disclose a low complexity method to estimate the synchronization position m₀, which indicates the start of a known training signal carried by the received signal, e.g. the first signal r₁^{w}.

Let r₁^{w}=[r₁ r₂ . . . r_{w}]^{T} be the first signal, e.g. a baseband received signal, buffered up to a certain window length w. Furthermore, let t₁ⁿ=[t₁ t₂ . . . tₙ]^{T} be the known training signal. In the IEEE 802.11, both the STF and the LTF may be combined to be used as the training signal. Alternatively, only parts of the STF and/or LTF may be combined to be used as the training signal. For example, the first samples of the STF may be omitted, while the remaining samples are combined with the LTF in order to form the training signal. This may be useful when receiver non-linearities, such as transients due to settling of an Automatic Gain Control (AGC), have distorted the beginning of the received signal.

The signals, e.g. the received signal and the training signal, are time delayed a period of time. The period of time of the time delay is sometimes in this disclosure referred to as a lag d, which sometimes in this disclosure also is referred to as a time shift or a sample delay.

In some first embodiments, time delayed signals r′(k) and t′(k) are formed as:

r′(k)=r(k)r*(k+d), k=1, . . . , w−d,

t′(k)=t(k)t*(k+d), k=1, . . . , n−d,

The expression “*” denotes element-wise complex conjugation. Using these transformed signals we now perform cross correlation, i.e. matched filter.

$$y ( m ) = {\sum }_{l = 1}^{n - d} {( {r}^{′} ( l + m - 1 ) )}^{*} {t}^{′} ( l )$$

By performing the non-linear self-multiplication operation, the effect of frequency offset is reduced or eliminated, and the resulting estimate of the time synchronization position \hat{m}₀ is robust to frequency offsets.

Indeed, if the received samples are written in the form

rₖ=e^{jωk}xₖ+vₖ,

wherein xₖ are noiseless desired signal samples, vₖ models the noise, and ω is the frequency offset, then

r′ₖ=rₖr*_{k+d}=xₖx*_{k+d}e^{-jωd}+vₖv*_{k+d}.

Hence, the rotation e^{jωk} imparted on the desired signal sample xₖ by the frequency offset ω has been eliminated from r′ₖ.

The time synchronization position \hat{m}₀ is estimated by computing the peak of the cross correlation:

\hat{m}₀=arg maxₘ{|y(m)|}+d.

However, note that in some first embodiments described above two new signals which have d fewer samples than the original signals were created. The reduction in the number of samples is minimized by taking d=1. That is by taking the sample delay d to be equal to one unit, e.g. one time unit.

In some second embodiments, the following time delayed signals are created:

$${r}^{″} ( k ) = \{ \begin{matrix}r ( k + d ) {r}^{*} ( k ) , & k = 1 , … w - d \\ r ( k - w + d ) {r}^{*} ( k ) , & k = w - d + 1 , … , w\end{matrix} \\ {t}^{″} ( k ) = \{ \begin{matrix}t ( k + d ) {t}^{*} ( k ) , & k = 1 , … n - d \\ t ( k - n + d ) {t}^{*} ( k ) , & k = n - d + 1 , … , n\end{matrix}$$

and cross correlation between these signals are performed. Note that r″ has the same length as the first signal r₁^{w}. The cross-correlation is then give by

$${y}^{″} ( m ) = {\sum }_{l = 1}^{n} {( {r}^{″} ( l + m - 1 ) )}^{*} {t}^{″} ( l )$$

and the time synchronization position \hat{m}₀ is obtained as before:

\hat{m}₀=arg maxₘ{|y″(m)|}.

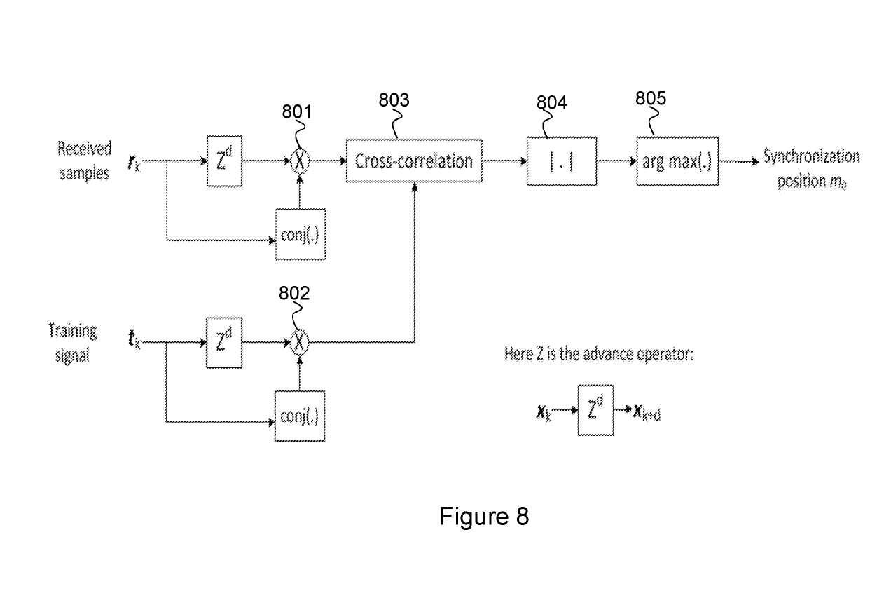

Other similar embodiments are possible, for example by interchanging the order of conjugation and delays, as shown in FIG. 8 that schematically illustrates another example of a block diagram comprising functional entities which can be used for estimating the time synchronization position \hat{m}₀.

As schematically illustrated in FIG. 8, in a block 801, sample by sample, a delayed received baseband signal rₖ is multiplied with a conjugated version of itself. In the FIG. 8, z^{d} illustrates an advance/delay operator and d is the lag. Further, in a block 802, a delayed training field sequence tₖ comprising all or parts of the STF and LTF is multiplied with a conjugated version of itself. In a block 803, a matched filter is performed, e.g. the outputs from the first and second actions are cross-correlated. Further, in a block 804, the absolute value of an input is taken as an output. This is illustrated with the notation |.|. Thus, the result of the cross-correlation performed in block 803 is given as input to block 804 and the output of block 804 is the absolute value of the result of the cross-correlation. In a block 805, the output of the matched filter is used to estimate the synchronization position \hat{m}₀ .

It should be understood that, even more embodiments may be obtained by minor modifications of the embodiments disclosed herein.

| Abbreviation | Explanation |
|---|---|
| AWGN | Additive White Gaussian Noise |
| IEEE | Institute of Electrical and Electronics Engineers |
| LAN | Local Area Network |
| LTF | Long Training Field |
| MCS | Modulation and Coding Scheme |
| SNR | Signal to Noise Ratio |
| STF | Short Training Field |
| WLAN | Wireless Local Area Network |

When the word “comprise” or “comprising” is used in this disclosure it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1-32. (canceled)

33. A method, performed by a receiving node, for estimating a time synchronization position (\hat{m}₀) of a signal received from a transmitting node, the method comprising:
receiving a first signal (r₁^{w}) from the transmitting node, wherein the first signal comprises a first training signal (t₁ⁿ), the first training signal being known to both the receiving node and the transmitting node;
performing a non-linear transformation of the first signal resulting in a first non-linearly transformed signal;
performing a non-linear transformation of the first training signal resulting in a second non-linearly transformed signal;
performing a cross-correlation between the first non-linearly transformed signal and the second non-linearly transformed signal; and
estimating the time synchronization position (\hat{m}₀) of the first signal based on the cross-correlation.

34. The method of claim 33, wherein the performing of the non-linear transformation of the first signal comprises:
creating a second signal (r₂^{w}) as a copy of the first signal;
performing a complex-conjugation of the first signal or the second signal, the complex-conjugation resulting in a complex-conjugated signal and a non-complex conjugated signal;
time-shifting the complex-conjugated signal and the non-complex conjugated signal in relation to each other; and
element-wise multiplying with each other the complex-conjugated signal and the non-complex conjugated signal with the complex-conjugated signal and non-complex conjugated signal time-shifted in relation to each other.

35. The method of claim 33, wherein the performing the non-linear transformation of the first training signal comprises:
creating a second training signal (t₂ⁿ) as a copy of the first training signal;
performing a complex-conjugation of the first training signal or the second training signal, the complex-conjugation resulting in a complex-conjugated training signal and a non-complex conjugated training signal;
time-shifting the complex-conjugated training signal and the non-complex conjugated training signal in relation to each other; and
element-wise multiplying with each other the complex-conjugated training signal and the non-complex conjugated training signal with the complex-conjugated training signal and non-complex conjugated training signal time-shifted in relation to each other.

36. A receiving node for estimating a time synchronization position (\hat{m}₀) of a signal received from a transmitting node, wherein the receiving node comprises:
processing circuitry;
memory containing instructions executable by the processing circuitry whereby the receiving node is operative to:
receive a first signal (r₁^{w}) from the transmitting node, wherein the first signal comprises a first training signal (t₁ⁿ), the first training signal being known to both the receiving node and the transmitting node;
perform a non-linear transformation of the first signal resulting in a first non-linearly transformed signal (r′,r”);
perform a non-linear transformation of the first training signal resulting in a second non-linearly transformed signal (t′,t″);
perform a cross-correlation of the first non-linearly transformed signal and the second non-linearly transformed signal; and
estimate the time synchronization position (\hat{m}₀) of the first signal based on the cross-correlation.

37. The receiving node of claim 36, wherein the instructions are such that the receiving node is operative to perform the non-linear transformation of the first signal by:
creating a second signal (r₂^{w}) as a copy of the first signal;
performing a complex-conjugation of the first signal or the second signal, the complex-conjugation resulting in a complex-conjugated signal and a non-complex conjugated signal;
time-shifting the complex-conjugated signal and the non-complex conjugated signal in relation to each other; and
element-wise multiplying with each other the complex-conjugated signal and the non-complex conjugated signal with the complex-conjugated signal and non-complex conjugated signal time-shifted in relation to each other.

38. The receiving node of claim 36, wherein the instructions are such that the receiving node is operative to perform the non-linear transformation of the first training signal by:
creating a second training signal as a copy of the first training signal;
performing a complex-conjugation of the first training signal or the second training signal, the complex-conjugation resulting in a complex-conjugated training signal and a non-complex conjugated training signal;
time-shifting the complex-conjugated training signal and the non-complex conjugated training signal in relation to each other; and
element-wise multiplying with each other the complex-conjugated training signal and the non-complex conjugated training signal with the complex-conjugated training signal and non-complex conjugated training signal time-shifted in relation to each other.

39. The receiving node of claim 36, wherein the first non-linearly transformed signal is given by:
r′(k)=r(k)r*(k+d), k=1, . . . , w−d,
where k is the sample index, w is a window length of a buffer for a received signal, d is the sample delay, and the expression “*” denotes element-wise complex conjugation.

40. The receiving node of claim 36, wherein the second non-linearly transformed signal is given by:
t′(k)=t(k)t*(k+d), k=1, . . . , n−d,
wherein k is the sample index, n is a length of the first training signal, d is the sample delay, and wherein the expression “*” denotes element-wise complex conjugation.

41. The receiving node of claim 36, wherein the instructions are such that the receiving node is operative to perform the cross-correlation of the first non-linear transformed signal and the second non-linear transformed signal as:
y(m)=Σₗ₌₁^{n-d}(r′(l+m−1))*t′(l),
wherein y(m) is a cross-correlated signal, m is a sample index, and the expression “*” denotes element-wise complex conjugation.

42. The receiving node of claim 40, wherein the instructions are such that the receiving node is operative to estimate the time synchronization position of the first signal based on the cross-correlation by estimating the synchronization position based on a maximum value or a minimum value of the cross-correlation.

43. The receiving node of claim 42, wherein the instructions are such that the receiving node is operative to estimate the time synchronization position of the first signal based on the cross-correlation by estimating the time synchronization position as
\hat{m}₀=arg maxₘ{|y(m)|}+d,
wherein y(m) is the cross-correlated signal, m is a sample index, and d is the sample delay.

44. The receiving node of claim 36, wherein the first non-linearly transformed signal is given by:
$${r}^{″} ( k ) = \{ \begin{matrix}r ( k + d ) {r}^{*} ( k ) , & k = 1 , … w - d \\ r ( k - w + d ) {r}^{*} ( k ) , & k = w - d + 1 , … , w\end{matrix}$$
wherein k is the sample index, d is the sample delay, w is the window length of a buffer for a received signal, and the expression “*” denotes element-wise complex conjugation.

45. The receiving node of claim 44, wherein the second non-linearly transformed signal is given by:
$${t}^{″} ( k ) = \{ \begin{matrix}t ( k + d ) {t}^{*} ( k ) , & k = 1 , … n - d \\ t ( k - n + d ) {t}^{*} ( k ) , & k = n - d + 1 , … , n\end{matrix}$$
wherein k is the sample index, d is the sample delay, n is a length of the first training signal, and the expression “*” denotes element-wise complex.

46. The receiving node of claim 44, wherein the instructions are such that the receiving node is operative to perform the cross-correlation of the first non-linearly transformed signal and the second non-linear transformed signal as:
y″(m)=Σₗ₌₁^{n-d}(r″(l+m−1))*t″(l),
wherein y″(m) is a cross-correlated signal, m is a sample index, and the expression “*” denotes element-wise complex conjugation.

47. The receiving node of claim 46, wherein the instructions are such that the receiving node is operative to estimate the time synchronization position of the first signal based on the cross-correlation by estimating the synchronization position based on a maximum value or a minimum value of the cross-correlation.

48. The receiving node of claim 47, wherein the instructions are such that the receiving node is operative to estimate the time synchronization position of the first signal based on the cross-correlation by estimating the time synchronization position as
\hat{m}₀=arg maxₘ{|y″(m)|},
wherein y″(m) is the cross-correlated signal, m is the sample index, and d is the sample delay.
